(19) United States
(12) Patent Application Publication
(10) Pub. No.: US 2022/0384894 A1
(43) Pub. Date: Dec. 1, 2022

(54) BATTERY PACK AND ELECTRICAL INSTRUMENT

(71) Applicant: Koki Holdings Co., Ltd., Tokyo (JP)

(72) Inventors: Toshiyuki YOSHIDA, Ibaraki (JP); Hiroyuki HANAWA, Ibaraki (JP)

(73) Assignee: Koki Holdings Co., Ltd., Tokyo (JP)

(21) Appl. No.: 17/771,010

(22) PCT Filed: Sep. 25, 2020
(86) PCT No.: PCT/JP2020/036446

§ 371 Date: Apr. 22, 2022

(30) Foreign Application Priority Data
Oct. 31, 2019 (JP) 2019-198079

(51) Int. Cl. H01M 50/244; H01M 50/213; H01M 50/247; H01M 50/262

(52) U.S. Cl. CPC H01M 50/244; H01M 50/213; H01M 50/247; H01M 50/262; H01M 2220/30

(57) ABSTRACT

Inside a case of a battery pack, the case being formed from an upper case and a lower case, battery cells are aligned in the longitudinal direction, with three battery cells stacked on the upper side and two stacked on the lower side. Portions of the end surfaces of the upper battery cells are supported in the axial direction by cell support parts formed integrally with the inner wall of the lower case. Similarly, portions of the end surfaces of the lower battery cells are supported in the axial direction by cell support parts formed integrally with the inner wall of the lower case. The cell support parts are formed independently from each other.

### TECHNICAL FIELD

The present invention relates to a battery pack which supplies power to an electrical instrument main body including a load device such as a motor and lighting. Further, it also relates to an electrical instrument which operates an operation device by mounting with the battery pack.

### RELATED ART

Electrical instruments such as electrical tools are driven by battery packs using secondary batteries such as lithium-ion batteries and are becoming cordless. For example, in a hand-held electrical tool which drives a front end tool by a motor, a battery pack accommodating a plurality of secondary battery cells is used as a power source to drive a load device such as a motor by the electric energy stored in the battery pack. The battery pack is configured to be removable from the electrical tool main body, and when the voltage drops upon discharge, the battery pack is removed from the electrical tool main body to be charged using an external charger. An example of such a battery pack is disclosed in the technique of Patent Document 1.

In the battery pack of Patent Document 1, four lithium-ion secondary battery cells rated at 3.6V are connected in series and two sets of these are connected in parallel to realize a battery pack rated at 14.4V. Such a conventional battery pack will be described with reference to FIG. 16. A battery pack 300 accommodates a total of eight battery cells 341 to 348 inside a space defined by an upper case 310 and a lower case 320 made of synthetic resin. Two rail parts (not shown in the figure) extending in parallel toward a mounting direction of the battery pack 300 are provided on left and right sides of the upper case 310 of the battery pack 300, and latch mechanisms (not shown in the figure) are provided on left and right sides on a rear side of the rail parts to hold and prevent the battery pack from falling off the electrical tool. Among the battery cells 341 to 348, four battery cells are arranged orderly on a lower side and four battery cells are arranged orderly on an upper side, and the battery cells 341 to 348 are arranged so that their longitudinal direction extends in a direction orthogonal to the extending direction (front-rear direction) of the rail part, i.e., extending in a left-right direction. The battery cells 341 to 348 are held by a separator 330 made of synthetic resin. If 18.0V is to be outputted with the battery pack 300 shown in FIG. 16, the size of the upper case 310 and the lower case 320 would be changed to stretch to the rear side, and two more battery cells would be added to the rear side of the battery cells 344 and 348 or to the front side of the battery cells 341 and 345 to arrange five battery cells on the upper step and five battery cells on the lower step.

### RELATED ART DOCUMENTS

### Patent Document

[Patent Document 1] Japanese Patent Application Laid-Open No. 2012-051064

### SUMMARY OF INVENTION

### Problem to be Solved by Invention

In cordless electrical instruments, it is required to secure a predetermined operating time and a predetermined output, and as the performance of the secondary battery improves, higher voltage and higher output are being sought. On the other hand, to improve operability, it is desired to realize a compact and lightweight battery pack. When lithium battery cells are used as the secondary batteries, a common 18650 size battery cell is arranged so that its longitudinal direction is oriented in the left-right direction. In recent years, instead of the 18650 size, as the type of battery cell, a large-diameter and long battery cell such as 21700 has become widespread. When a battery pack is realized by using a battery cell (hereinafter referred to as a “large-diameter battery cell”) such as 21700 that is thicker than the conventional battery cell, a battery pack having about the same capacity as a battery pack using ten 18650-size battery cells can be realized with five large-diameter battery cells. However, if the large-diameter battery cells are arranged so that their longitudinal direction is arranged in the left-right direction as in the conventional art, a lateral width (size in left-right direction) and a length (size in front-rear direction) of the case of the battery pack would increase, making the battery pack difficult to use.

On the other hand, with the realization of larger capacity of battery packs in recent years, the number of high-output electrical instrument products is increasing. In electrical tools, the output of motors is increasing along with the increase in the output of battery packs, and it has become an apparent problem that the weight of the tool main body increases and the vibration and output during operation tend to increase. Along with this, the requirement for mechanical strength against dropping and vibration required for the battery pack also increases. In the components inside the battery pack, having a high percentage of mass of the battery cells and reducing rattling between the battery cells and the case accommodating them contribute to prevention of breakage of tab joint parts connecting the battery cells to each other and to other components and prevention of deformation of the battery cells. However, if the battery cell has a slightly different length (e.g., about 0.1 to 0.3% of the length of the battery cell) due to manufacturing variations and the case of the battery pack is made of resin, it has been found by the inventors' examination that rattling may increase and the mechanical strength may decrease especially when a short cell is present.

The present invention has been made in view of the above background, and an objective thereof is to realize a small and lightweight battery pack and an electrical instrument using the same by changing an arrangement direction and a stacking method of battery cells in the battery pack. Another objective of the present invention is to realize a battery pack which suppresses rattling and an electrical instrument using the same by improving a shape of a cell support part which supports the battery cell and is formed on a case of the battery pack. Still another objective of the present invention is to realize a battery pack and an electrical instrument using the same capable of effectively suppressing breakage of tab joint parts of battery cells and deformation of the battery cells when a strong impact such as dropping is applied to the battery pack.

### Means for Solving Problem

The following is a description of representative features of the invention disclosed in the present application. A feature of the present invention includes a case, a plurality of battery cells, and an upper-side cell support part and a lower-side cell support part. The case forms an outer frame. The plurality of battery cells are formed by bale-stacking upper-side battery cells located on an upper side and lower-side battery cells located on a lower side in the case. In a longitudinal direction of the battery cell, the upper-side cell support part is provided at a position opposed to the upper-side battery cell, and the lower-side cell support part is provided at a position opposed to the lower-side battery cell. The upper-side cell support part and the lower-side cell support part opposed to each battery cell are independent of each other. The upper-side cell support part and the lower-side cell support part are integrally formed with the case. Further, the upper-side cell support part and the lower-side cell support part are each provided on two sides in the longitudinal direction of the battery cell.

According to another feature of the present invention, the upper-side cell support part and the lower-side cell support part have a fragile part. In the case, more upper-side battery cells are arranged in a radial direction and bale-stacked than the lower-side battery cells, and a support part supports an upper-side battery cell located at an end of the upper-side battery cells from below.

According to still another feature of the present invention, a battery pack includes a plurality of battery cells which are bale-stacked, and includes a support part supporting upper-side battery cells located at two ends in an arrangement direction of the battery cells from below. The support part is integrally formed with the case. Further, an upper-side cell support part and a lower-side cell support part are included. In a longitudinal direction of the battery cell, the upper-side cell support part is provided at a position opposed to the upper-side battery cell and the lower-side cell support part is provided at a position opposed to the lower-side battery cell, and the upper-side cell support part and the lower-side cell support part opposed to each battery cell are independent of each other. Further, the upper-side cell support part is provided to protrude inward from the case, and the lower-side cell support part is provided to protrude inward from the case at a position lower than the upper-side cell support part in a state separated from the upper-side cell support part. With the above configuration, the battery pack and an electrical instrument main body are realized, the electrical instrument main body including a battery pack mounting part having a rail groove to which the battery pack is capable of being mounted and a locking claw which is locked to the rail groove. The electrical instrument main body causes a load part such as a motor which consumes electric power supplied from the battery pack to operate.

### Effects of Invention

According to the present invention, it is possible to realize a small and lightweight battery pack and an electrical instrument and suppress rattling of the battery cells with respect to the case. Further, it is possible to suppress breakage of tabs of the battery cells and deformation of the battery cells. Further, in order to reduce rattling between the battery cells having different lengths and the case, the cells are arranged in a bale-stack and each battery cell is provided with a cell support part which acts independently; therefore, it is possible to improve resistance against impact due to dropping and vibration resistance against vibration of the electrical tool. Furthermore, since a fragile part is formed by a plurality of ribs in the cell support part, and the amount of deformation of the fragile part changes according to the size of the cell, there is no concern of being affected by the size of the adjacent battery cells. Furthermore, since rattling can be effectively suppressed even if a long battery cell is present next to a short battery cell, it is no longer necessary to install elastic spacers, which contributes to reduction in the manufacturing costs.

### BRIEF DESCRIPTION OF DRAWINGS

FIG. 1 is a perspective view of an electrical tool main body 1 and a battery pack 100 to be mounted thereon according to an embodiment of the present invention.

FIG. 2 is a single unit view of the battery pack 100 of this embodiment, in which (A) is a top view, (B) is a left side view, and (C) is a rear view.

FIG. 3 is an exploded perspective view of the battery pack 100 according to the embodiment of the present invention (No. 1).

FIG. 4 is an exploded perspective view of the battery pack 100 of FIG. 3 (No. 2).

FIG. 5 is a view showing a state in which the insulating sheet 178 is removed from an assembly of a separator 250 of FIG. 3 and FIG. 4, in which (A) is a perspective view of the assembly of the separator 250 viewed from the front, and (B) is a perspective view of the assembly of the separator 250 viewed from the rear.

FIG. 6 is a perspective view showing a single unit of the separator 250 of FIG. 3.

FIG. 7 is a top view of a lower case 200 of FIG. 3 showing storage positions of the battery cells 145 to 149 to be accommodated.

FIG. 8 is a cross-sectional view of an A-A part of FIG. 2.

FIG. 9 is the same cross-sectional view as FIG. 8, emphasizing contact portions between upper-side cell support parts 211 to 213 and the battery cells 145 to 147, and between lower-side cell support parts 214 and 215 and the battery cells 148 and 149.

FIG. 10 is a cross-sectional view of a B-B part of FIG. 2.

FIG. 11 is a perspective view of a single unit of the lower case 200 of FIG. 3.

FIG. 12 is a view of a single unit of the lower case 200 of FIG. 3, in which (A) is a plan view, (B) is a cross-sectional view of a C-C part of (A), and (C) is a cross-sectional view of a D-D part of (A).

FIG. 13 is a partially enlarged view of an E part in (A) of FIG. 12.

FIG. 14 is a view of the battery pack 100 of FIG. 1, in which (A) is a top view, (B) is a cross-sectional view of an F-F part of (A), and (B) is a cross-sectional view of a G-G part of (A).

(A) of FIG. 15 is a cross-sectional view of an H-H part of (A) of FIG. 14, and (B) of FIG. 15 is a cross-sectional view of an I-I part of (A) of FIG. 14.

FIG. 16 is a vertical cross-sectional view of a conventional battery pack.

### DESCRIPTION OF EMBODIMENTS

### Embodiment 1

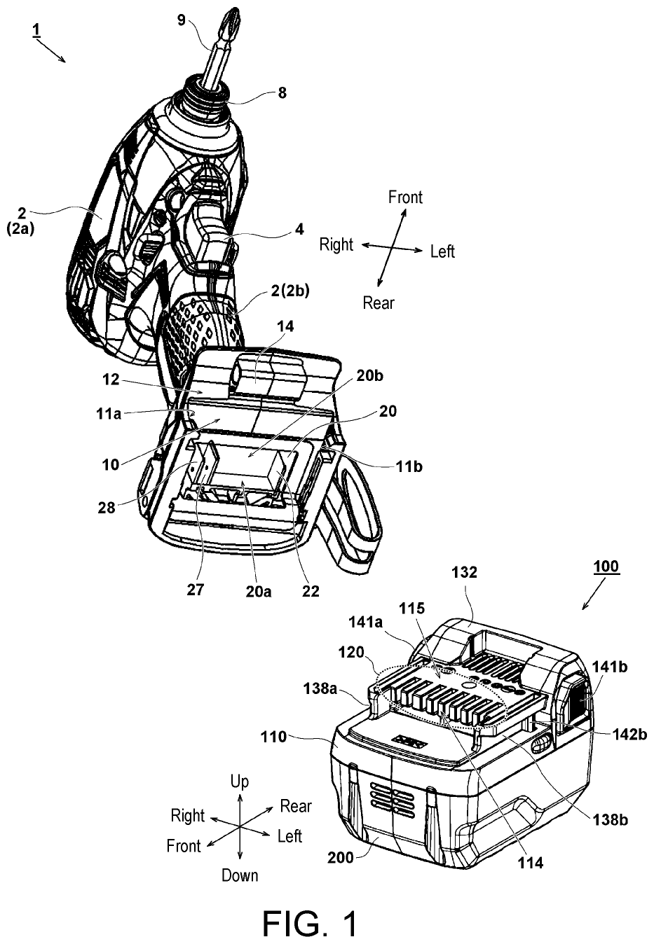

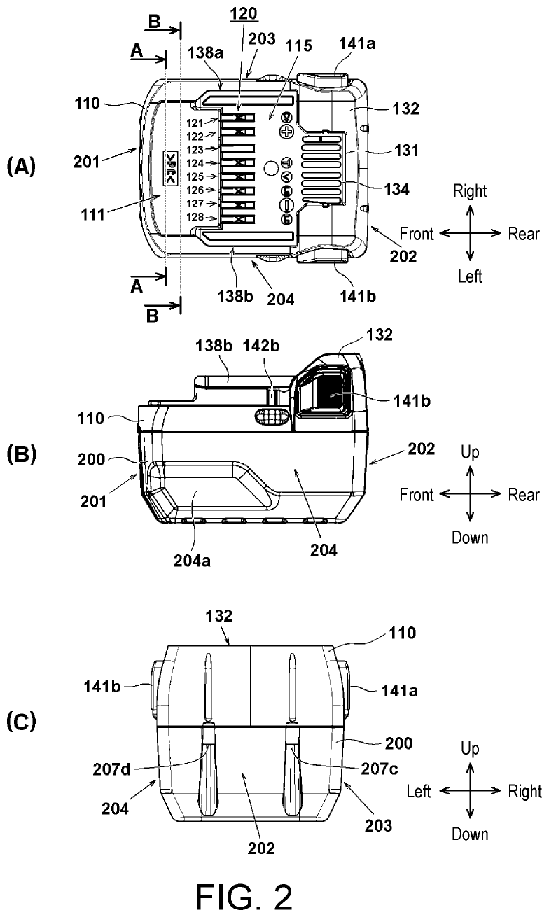

Hereinafter, embodiments of the present invention will be described with reference to the drawings. In the following figures, the same parts will be labeled with the same reference signs, and repeated descriptions will be omitted. In this specification, as an example of an electrical instrument, an electrical tool (impact tool) operated by a battery pack will be illustrated and described. The front, rear, left, and right directions on a main body side of the electrical tool will be described as the directions shown in FIG. 1, and the front, rear, left, right, upper, and lower directions when the battery pack is viewed as a single unit will be described as the directions shown in FIG. 1, FIG. 2, etc. with respect to a mounting direction of the battery pack.

FIG. 1 is a perspective view of an electrical tool main body 1 and a battery pack 100 to be mounted thereon according to this embodiment. An electrical tool, which is a form of an electrical instrument, has a battery pack 100 and drives a front end tool or an operation device by using a rotational driving force based on a motor (not shown). While the electrical tool has been realized in various types, an impact tool shown in FIG. 1 performs a tightening operation by applying a rotational force or a striking force in an axial direction to a front end tool 9. The electrical tool main body 1 includes a housing 2 serving as an outer frame forming an outer shape. The housing 2 is composed of a body part 2a which accommodates a motor and a power transmission mechanism (not shown), a handle part 2b which extends downward from the body part 2a, and a battery pack mounting part 10 formed on a lower side of the handle part 2b. A trigger-shaped operation switch 4 is provided near a portion of the handle part 2b where the index finger is rested when an operator grips the handle part 2b. An anvil (not shown in the figure) serving as an output shaft is provided on a front side of the housing 2, and a front end tool holding part 8 for mounting the front end tool 9 is provided at a front end of the anvil. Herein, a plus driver bit is mounted as the front end tool 9.

11a and 11b including grooves extending in parallel in a front-rear direction are formed on inner wall portions on left and right sides in the battery pack mounting part 10, and a terminal part 20 is provided therebetween. The terminal part 20 is manufactured by integrally molding a non-conductor material such as synthetic resin, and a plurality of terminals made of metal, e.g., a positive electrode input terminal 22, a negative electrode input terminal 27, and an LD terminal (abnormal signal terminal) 28 are cast therein. The terminal part 20 is formed with a vertical surface 20a which is an abutting surface in a mounting direction (front-rear direction) and a horizontal surface 20b, and the horizontal surface 20b is a surface adjacent to and opposed to an upper step surface 115 when the battery pack 100 is mounted. A curved part 12 which abuts with a raised part 132 of the battery pack 100 is formed on a front side of the horizontal surface 20b, and a protruding part 14 is formed near a left-right center of the curved part 12. While also serving as a boss for screwing the housing of the electrical tool main body 1 formed in two portions in a left-right direction, the protruding part 14 serves as a stopper which limits relative movement of the battery pack 100 in the mounting direction.

The battery pack 100 includes five lithium-ion battery cells rated at 3.6V accommodated in a case composed of an upper case 110 and a lower case 200, and outputs a direct current rated at 18V. A plurality of slots 121 to 128 (see FIG. 2 for reference signs) extending to the rear side from a step part 114 in the front at the upper step surface 115 are formed in a slot group arrangement region 120 of the battery pack 100. Two rail parts 138a and 138b are formed on a side surface of the upper step surface 115 of the battery pack 100. The rail parts 138a and 138b are formed so that their longitudinal direction is parallel to the mounting direction of the battery pack 100. Groove portions of the rail parts 138a and 138b have a front side end which is open-ended and a rear side end which is connected with a front side wall surface of the raised part 132 and is closed-ended. When removing the battery pack 100 from the electrical tool main body 1, by pushing latches 141a and 141b on the left and right sides, claw-shaped locking parts 142a (not shown in the figure) and 142b move inward to release the locked state, and in this state, the battery pack 100 is moved to a side opposite to the mounting direction.

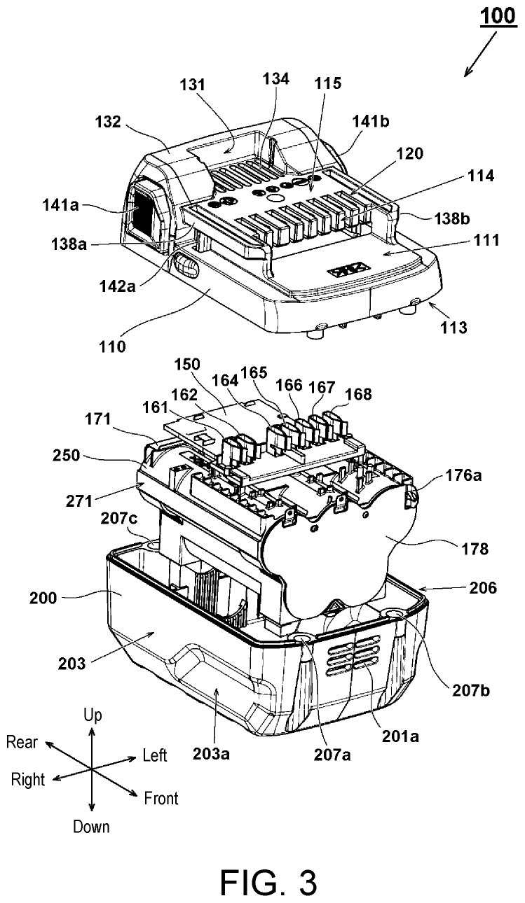

FIG. 2 is a single unit view of the battery pack 100, in which (A) is a top view, (B) is a left side view, and (C) is a rear view. The two rail parts 138a and 138b are formed in parallel to extend in the front-rear direction. The slot group arrangement region 120 is arranged on the upper step surface 115 sandwiched between the rail parts 138a and 138b, and eight slots 121 to 128 are formed in the slot group arrangement region 120. The slots 121 to 128 are portions cut out to have a predetermined length in the battery pack mounting direction, and a plurality of connection terminals (to be described later in FIG. 3) fittable with instrument-side terminals of the electrical tool main body 1 or an external charging device (not shown) are arranged inside the cut-out portions. The slots 121 to 128 have notches formed respectively on a vertical surface and an upper surface parallel to the mounting direction so that the terminals on the electrical tool main body side can be inserted from a lower step surface 111 side.

Among the slots 121 to 128, on a side close to the right-side rail part 138a of the battery pack 100, the slot 121 serves as an insertion port for a positive electrode terminal (C +terminal) for charging, and the slot 122 serves as an insertion port for a positive electrode terminal (+terminal) for discharging. Further, the slot 127 on a side close to the left-side rail part 138b of the battery pack 100 serves as an insertion port for a negative electrode terminal (−terminal). Between the positive electrode terminals and the negative electrode terminal, a plurality of signal terminals are arranged for signal transmission used for control to the battery pack 100 and the electrical tool main body 1 or the external charging device (not shown), and herein, four slots 123 to 126 for signal terminals are provided between the power terminal groups. The slot 123 is a spare terminal insertion port, and no terminal is provided therein in this embodiment. The slot 124 is an insertion port for a T terminal for outputting a signal, which is identification information of the battery pack 100, to the electrical tool main body or the charging device. The slot 125 is an insertion port for a V terminal for inputting a control signal from the external charging device (not shown). The slot 126 is an insertion port for an LS terminal for outputting battery temperature information according to a thermistor (temperature sensitive element) (not shown) provided in contact with the cell. Further, the slot 128 for an LD terminal, which outputs an abnormal stop signal according to a battery protection circuit (to be described later) included in the battery pack 100, is provided on a left side of the slot 127 serving as the insertion port for the negative electrode terminal (−terminal).

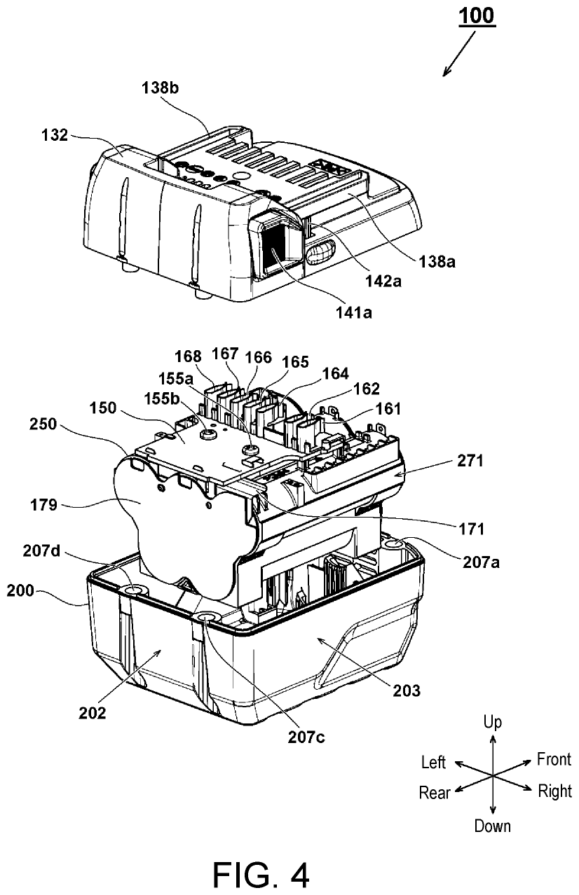

The latches 141a and 141b serving as operation buttons of a latch mechanism are provided at a rear side of side surfaces of the battery pack 100. A stopper part 131 which is recessed downward from the raised part 132 is formed near a center sandwiched between the latches 141a and 141b. The stopper part 131 serves as an abutting surface of the protruding part 14 (see FIG. 1) when the battery pack 100 is mounted on the battery pack mounting part 10, and when the protruding part 14 on the electrical tool main body 1 side is inserted until abutting on the stopper part 131, a plurality of terminals (instrument-side terminals) arranged on the electrical tool main body 1 and a plurality of connection terminals (to be described later in FIG. 4) arranged on the battery pack 100 come into contact with each other to be in a conductive state.

A plurality of slits 134 serving as cooling air intake ports connected to the inside of the battery pack 100 are provided on an inner side of the stopper part 131 of the battery pack 100. With the battery pack 100 mounted on the electrical tool main body 1, the slit 134 is covered to be invisible from the outside and is in a closed state. When the battery pack 100 is connected to a charging device (not shown) for charging, the slit 134 is a window used to forcibly flow cooling air to inside the battery pack 100, and the cooling air taken into the battery pack 100 is exhausted to the outside through a slit 201a (to be described later in FIG. 3) serving as an exhaust window provided on a front wall of the lower case 200. The slit 134 may also be used as an exhaust window, and the slit 201a may also be used as a cooling air intake port.

The lower case 200 has a substantially rectangular parallelepiped shape with an opened upper surface, and is composed of a bottom surface, a front wall 201 extending in a direction vertical to the bottom surface, a rear wall 202, a right side wall 203, and a left side wall 204. In (B) of FIG. 2, on the front side of the latch 141b, the locking part 142b protrudes to the left direction at a lower part of the rail part 138b due to the action of a spring, and by engaging with a recess part (not shown) formed in the rail part 11a of the electrical tool main body 1, the battery pack 100 is prevented from falling off. A similar locking part 142a is also provided at the right-side rail part 138a. Recessed parts 203a (see FIG. 3 to be described later) and 204a indented inward are formed on a front lower side of the left side wall 204 and the right side wall 203 (not shown in the figure) of the lower case 200. In addition to the effect of increasing the strength of the lower case 200 by forming irregularities on the outer surface, the recessed part 204a also serves as a design point and has the effect of enabling the operator to easily grasp the battery pack 100 when holding the battery pack 100.

In (C) of FIG. 2, a joint surface between the upper case 110 and the lower case 200 is located immediately below the latches 141a and 141b, and the upper case 110 and the lower case 200 are fixed by screws (not shown). The lower case 200 is formed with screw bosses 207c and 207d having through-holes penetrating upward from below.

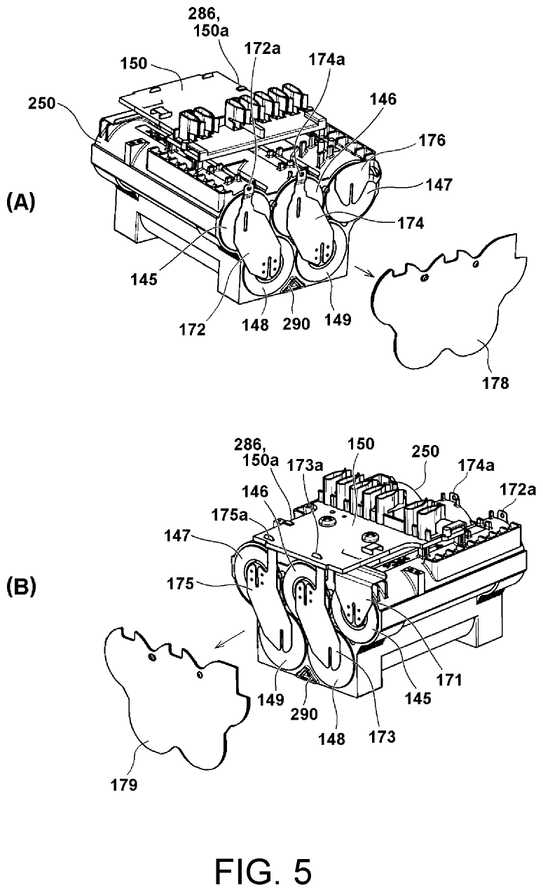

FIG. 3 is a perspective view of the battery pack 100 according to the embodiment of the present invention. The housing of the battery pack 100 is formed of the lower case 200 and the upper case 110 which may be divided in the up-down direction. The lower case 200 and the upper case 110 are made of a member which does not conduct electricity, e.g., synthetic resin. The upper case 110 is provided with a mounting mechanism for the battery pack 100 and a connection mechanism for establishing an electrical connection with the electrical instrument main body, and is formed with an opening 113 which is opened on the lower side. The lower case 200 is formed to accommodate five battery cells 145 to 149 (see FIG. 5 for reference signs) and has an opening 206 which is opened on the upper side. The upper case 110 and the lower case 200 are fixed to each other by aligning the openings 113 and 206 opposed to each other and penetrating four screws (not shown) through screw bosses 207a to 207d (see (C) of FIG. 2 for 207d).

The upper case 110 is formed with two rail parts 138a and 138b for attaching to the battery pack mounting part 10. The rail parts 138a and 138b are a mounting mechanism formed to have a longitudinal direction parallel to the mounting direction of the battery pack 100 and to protrude and be recessed in the left-right direction from the left and right side surfaces of the upper case 110. The rail parts 138a and 138b are formed in a shape corresponding to the rail parts 11a and 11b (see FIG. 2) formed on the battery pack mounting part 10 of the electrical tool main body 1, and with the rail parts 138a and 138b fitted with the rail parts 11a and 11b, the battery pack 100 is fixed to the electrical tool main body 1 by locking by the locking parts 142a and 142b (see FIG. 2) serving as the latch claws.

A flat lower step surface 111 is formed at a front side of the upper case 110, and an upper step surface 115 formed higher than the lower step surface 111 is formed near the center. The lower step surface 111 and the upper step surface 115 are formed in a stepped shape, and a connecting portion thereof is a step part 114 which is a vertical surface. A front side portion of the upper step surface 115 from the step part 114 forms the slot group arrangement region 120. A raised part 132 formed to be raised is formed on the rear side of the upper step surface 115, and a recess-shaped stopper part 131 and a slit 134 are formed near the center.

A separator 250 made of synthetic resin is accommodated in an internal space of the lower case 200. The separator 250 serves as a base for holding the five battery cells in a stacked state and for mounting a circuit board 150 which holds a connection terminal group on an upper side. The circuit board 150 fixes a plurality of connection terminals (161, 162, and 164 to 168), and electrically connects these connection terminals to a circuit pattern (not shown). The circuit board 150 is further mounted with various electronic elements (not shown herein) such as a battery protection IC, a microcomputer, a PTC thermistor, a resistor, and a capacitor. As the circuit board 150, a single-layer board, a double-sided board, or a multi-layer board may be used.

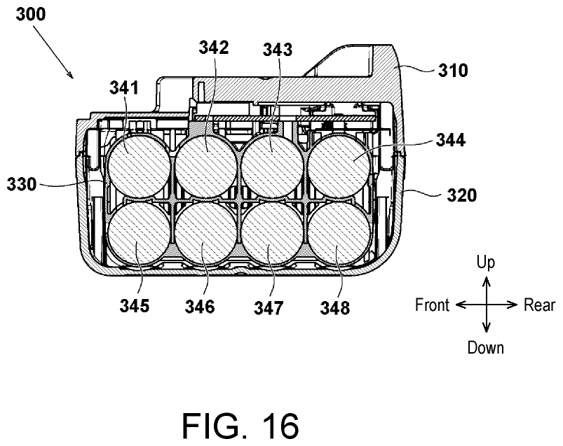

Positive electrode terminals 161 and 162 are arranged at the right side of the circuit board 150, and a negative electrode terminal 167 is arranged at the left side. Three signal terminals (T terminal 164, V terminal 165, and LS terminal 166) are provided therebetween. An LD terminal 168 is provided on the left side of the negative electrode terminal 167. These terminals for connection have an arm part which fits with the plate-shaped connection terminal on the electrical instrument main body side, and may be the same components as connection terminals used in a conventional battery pack 300 shown in FIG. 16.

An insulating sheet 178 is provided at front ends in the longitudinal direction of the battery cells 145 to 149 (not shown in the figure) accommodated in the separator 250. The insulating sheet 178 is made of a material which does not conduct electricity such as paper, and an inner portion thereof is coated with a sealing material. The insulating sheet 178 achieves electrical insulation and protects a portion of a connection tab (to be described later in FIG. 5), which is made of metal and provided at a battery cell end, contacting a support part of the lower case.

The internal space of the lower case 200 is shaped to be suitable for accommodating the separator 250, and a cell support part and a cell side surface support part (both to be described later) are formed to stably hold the separator 250. The lower case 200 is designed according to the number of battery cells to be accommodated and the size of the separator 250 changed accordingly. Herein, an upper case 110 used for a 18V battery pack that has already been commercialized is directly used as the upper case 110, and only the lower case 200 is redesigned and downsized according to the size and number of accommodated battery cells and the separator 250.

FIG. 4 is the same exploded perspective view as in FIG. 3 viewed from the rear side. The end of the battery cell is located also on the rear side of the separator 250 and the insulating sheet 179 is provided. Two screw bosses 207c and 207d are formed on a rear wall surface of the lower case 200. In the battery pack 100 of this embodiment, when an assembly mounted with five battery cells, installed with a circuit board, and attached with connection tabs (to be described later in FIG. 5) made of metal and the insulating sheets 178 (see FIG. 3) and 179 is to be accommodated inside the lower case 200, it is possible not to interpose a thin rubber sheet or sponge sheet. However, since it does not mean that it is absolutely unnecessary, it is also optional to interpose a thin rubber sheet or sponge sheet.

FIG. 5 is a perspective view showing a state in which only the insulating sheets 178 and 179 are removed from the assembly of the separator 250 of FIG. 3 and FIG. 4. (A) of FIG. 5 is a view of the separator 250 viewed diagonally from the front as in FIG. 3, and (B) of FIG. 5 is a view of the separator 250 viewed diagonally from the rear as in FIG. 4. The separator 250 accommodates five battery cells 145 to 149. Herein, so-called “21700 size” lithium-ion battery cells having a diameter of 21 mm and a length of 70 mm are used as the battery cells 145 to 149. The battery cells 145 to 149 are arranged with two cells being on the lower side and three cells being on the upper side so that their longitudinal direction is the front-rear direction. The battery cells 145 to 149 are held by the separator 250 made of synthetic resin to be in a so-called bale-stack state. Herein, “bale-stack” is a method in which outer peripheral surfaces of cylindrical battery cells are in contact with each other, and is a method in which the battery cells 145 to 147 on an upper step side and the battery cells 148 to 149 on a lower step side are stacked to be laterally shifted by a radius of the battery cell, so that a virtual plane connecting upper end positions of the battery cells on the lower step side is located above a virtual plane connecting lower end positions of the battery cells on the upper step side. In the front view or the rear view, when radial centers of the battery cells are connected by a virtual line in a sequence of the battery cells 145, 148, 146, 149, and 147, the battery cells 145 to 149 are arranged in a substantially W shape in the lower case 200. By bale-stacking the battery cells 145 to 149 in this manner, the height required for stacking the two steps can be made smaller than 2R (R is the diameter of the battery cell). Herein, instead of a stacking method in which the battery cells 145 to 149 are in direct contact with each other, the separator 250 covers most of the outer peripheral surface, and the battery cells 145 to 149 do not come into direct contact with each other. The type of the battery cell is not limited to lithium-ion batteries, but any type of secondary battery such as a nickel-metal hydride battery cell, a lithium-ion polymer battery cell, and a nickel-cadmium battery cell may be used. Further, the size of the battery cell is not limited to the so-called “21700 size”, but may be larger or smaller than this size as long as it can be accommodated in the lower case.

The separator 250 (details will be described later) made of synthetic resin is formed with an inner cylinder part for the cylindrical battery cells 145 to 149 to penetrate through, and two longitudinal ends of the battery cells 145 to 149 are held to be exposed from the separator 250. In this state, the adjacent battery cells are connected by connection tabs 171 to 175 made of thin metal plates. There are various possible arrangement orientations of the battery cells 145 to 149, but herein, the upper-side battery cells 145 to 147 are arranged so that an axial front side is the negative electrode, and the lower-side battery cells 148 and 149 are arranged so that an axial front side is the positive electrode. However, the arrangement of the positive electrode and the negative electrode may also be reversed. As shown in (A) of FIG. 5, at axial front ends of the battery cells 145 to 147, the battery cells 145 and 148 are connected by the connection tab 172, and the battery cells 146 and 149 are connected by the connection tab 174. The battery cell 147 is provided with a connection tab 176 for connecting to the negative electrode terminal 167. Similarly, as shown in (B) of FIG. 5, at axial rear ends of the battery cells 145 to 147, the positive electrode of the battery cell 146 and the negative electrode of 148 are connected by the connection tab 173, and the positive electrode of the battery cell 147 and the negative electrode of 149 are connected by the connection tab 175. The positive electrode of the battery cell 145 is provided with a connection tab 171 for connecting to the positive electrode terminals 161 and 162.

The connection tabs 171 to 176 are fixed to the battery cells 145 to 149 by spot welding at four spots. To stabilize spot welding of the connection tabs 171 to 176, slits extending in the up-down direction are formed respectively in the connection tabs 171 to 176 to divide the four welding spots into two parts. Further, the connection tabs 172 to 175 are formed with lead-out parts 172a to 175a for monitoring an intermediate potential of the battery cells connected in series by a protection IC (not shown). Ends of the lead-out parts 172a and 174a are connected to the circuit board 150 by lead wires (not shown), and ends of the lead-out parts 173a and 175a are penetrated from a back surface side to a front surface side of the circuit board 150 through through-holes formed in the circuit board 150 and are soldered on the front surface side.

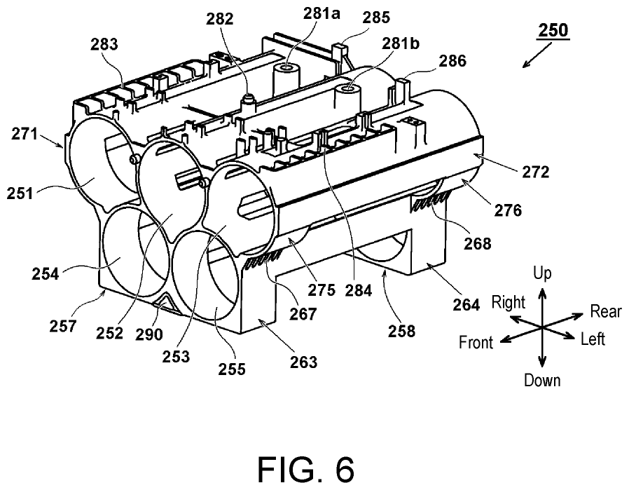

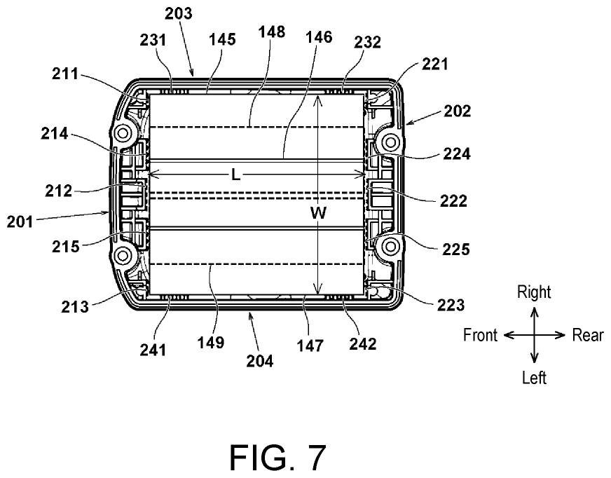

FIG. 6 is a perspective view showing a single unit of the separator 250 of FIG. 3. Five cell accommodating parts 251 to 255 in a cylindrical shape are formed in the separator 250 to stack the battery cells 145 to 149 so that their axes are parallel to each other. The length of the separator 250 in the front-rear direction is substantially the same as or slightly smaller than the length of the battery cells 145 to 149, and front end surfaces and rear end surfaces of the battery cells 145 to 149 are in a state exposed from the separator 250. In the cell accommodating parts 251 to 255, an outer edge near a front opening has a continuous wall surface, and an outer edge near a rear opening also has a continuous wall surface. On the other hand, a part of a side wall near the center in the front-rear direction of the cell accommodating parts 251 to 255 is cut out, and a part of the side surface of the battery cell is exposed to be visible from the outside of the separator 250. This cut-out portion serves for weight reduction of the separator 250. The separator 250 holds the stacked battery cells 145 to 149 so that they do not move relatively with respect to the lower case 200. Therefore, the separator 250 itself is also restricted by the lower case 200 from moving relatively in the up-down direction and the left-right direction. As to the movement in the up-down direction, in addition to leg parts 257 and 258 of the separator 250, the outer peripheral surfaces (abutting parts 273 to 276 of the separator 250 (273 and 274 are not shown in the figure)) of the battery cells 145 and 147 provided on the upper left and right sides are supported from directly below by cell support parts 231, 232, 241, and 242 (see FIG. 7 to be described later). Planar left-side abutting surfaces 263 and 264 are formed on side surfaces of the leg parts 257 and 258 of the separator 250. A plurality of ribs 267 and 268 formed in the vertical direction for reinforcement are formed on a side connecting part lower side of the cell accommodating parts 253 and 255 of the separator 250. Similarly, ribs (not shown in the figure) are formed on a side connecting part lower side of the cell accommodating parts 251 and 254, on the right side surface of the separator 250. The movement restriction of the separator 250 in the front-rear direction with respect to the lower case 200 is achieved by a protruding part 290 in a triangular shape provided at lower parts of the leg parts 257 and 258 between the cell accommodating part 254 and the cell accommodating part 255 in the left-right direction. The protruding part 290 is provided on the front and rear sides of the separator 250, and the front-side protruding part 290 abuts on a cell support part 212 (see FIG. 7 to be described later), and the rear-side protruding part 290 abuts on a cell support part 222 (see FIG. 7 to be described later).

Screw bosses 281a and 281b for fixing the circuit board 150 and a column part 282 which engages with a positioning hole (not shown) at the center of the circuit board 150 are formed on the upper side of the separator 250. Further, abutting parts 283 and 284 for good contact of the upper part of the separator 250 by the upper case 110 (see FIG. 4) are formed at edge parts of the separator 250 on the right and left sides of the circuit board 150. The abutting parts 283 and 284 are intended to reduce weight by forming parallel vertical ribs at equal intervals and abut with the lower surface of the upper case 110 over a wide range. On the rear side of the circuit board 150, two abutting parts 285 and 286 in a column shape are formed to abut with the lower surface (back surface) of the circuit board 150. Further, as shown in FIG. 5, a front end portion of the abutting part 286 is inserted into a notch 150a of the circuit board 150 to position the circuit board 150 with respect to the separator 250 together with the column part 282 and prevent rotation of the circuit board 150 with respect to the separator 250.

An abutting surface 271 for good surface contact with an inner wall surface of the lower case 200 is formed on a right side wall of the cell accommodating part 251 of the separator 250. Similarly, an abutting surface 272 for good surface contact with the inner wall surface of the lower case 200 is formed on a left side wall of the cell accommodating part 253 of the separator 250.

FIG. 7 is a top view of the lower case 200 of FIG. 3 showing storage positions of the battery cells 145 to 149 to be accommodated. A width W of an effective internal volume of the lower case 200 is substantially equivalent to a lateral width of three cells of the bale-stacked battery cells 145 to 149, and a length L is substantially equal to a length obtained by adding thicknesses of the connection tabs 171 to 176 and thicknesses of the insulating sheets 178 and 179 to a length of the battery cells 145 to 149. Herein, cell support parts 211 to 215 which respectively hold (or support) the battery cells 145 to 149 are provided at one longitudinal ends (front side) of the battery cells 145 to 149. The cell support parts 211 to 213 hold (or support) the battery cells 145 to 147 located on the upper side, and the cell support parts 214 and 215 hold (or support) the battery cells 148 and 149 located on the lower side. Similarly, cell support parts 221 to 225 which respectively hold (or support) the battery cells 145 to 149 are provided at other longitudinal ends (rear side) of the battery cells 145 to 149. The cell support parts 221 to 223 hold (or support) the battery cells 145 to 147 located on the upper side, and the cell support parts 224 and 225 hold (or support) the battery cells 148 and 149 located on the lower side. The cell support parts 211 to 215 and 221 to 225 are provided to protrude inward from the inner wall of the lower case 200. In FIG. 7, the connection tabs 171 to 176 and the insulating sheets 178 and 179 are omitted.

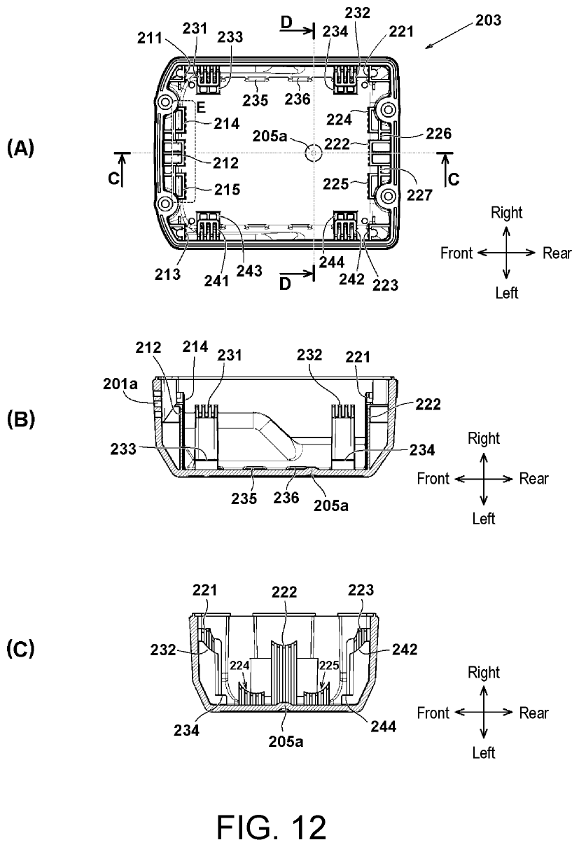

Cell support parts 231 and 232 are formed on the inner inside of the right side wall 203, on the right side of the battery cell 145. Similarly, cell support parts 241 and 242 are formed on the inner side of the left side wall 204. The cell support parts 231, 232, 241, and 242 are provided to protrude inward from the inner wall of the lower case 200. In this way, with the five battery cells 145 to 149 being held (or supported) by the cell support parts at two ends in the longitudinal direction, the battery cells 145 to 149 are held (or supported) so as not to rattle in the longitudinal direction, i.e., in the front-rear direction. Further, among the five battery cells 145 to 149, the battery cells 145 and 147 to 149 opposed to the right side wall 203 or the left side wall 204, i.e., the battery cells 145 and 147 located at two ends in the lateral direction in which the battery cells 145 to 147 are arranged, are supported by the cell support parts 231, 232, 241, and 242 which support the bottom surface side and the lateral surface side from below. The battery cells 148 and 149 arranged on the lower side are held by cell support parts 233, 234, 243, and 244, which are not shown in FIG. 7 (to be described later in FIG. 12).

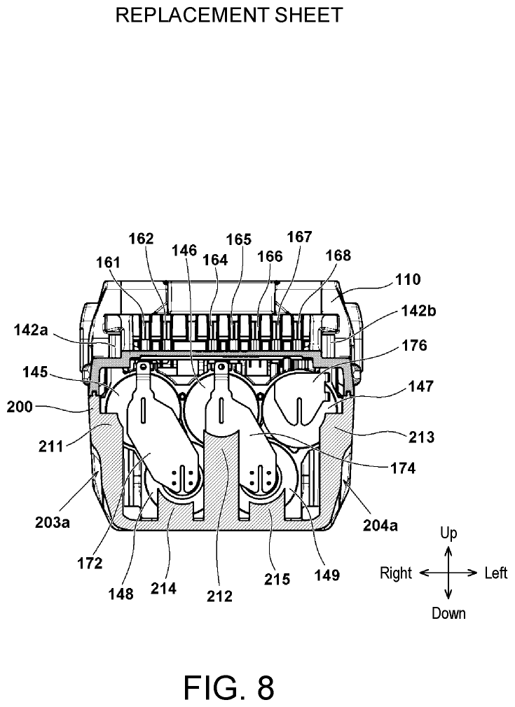

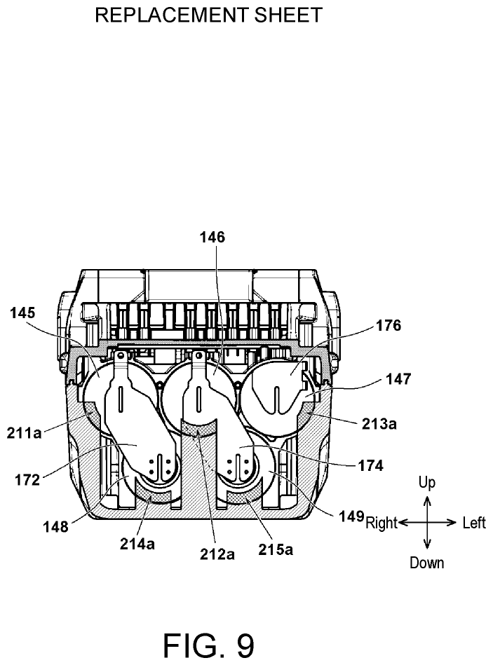

FIG. 8 is a cross-sectional view of an A-A part of FIG. 2, and FIG. 9 is the same cross-sectional view as FIG. 8. This cross-sectional position is slightly frontward than the front ends of the battery cells 145 to 149. In these figures, the insulating sheets 178 and 179 are omitted in order to illustrate the positional relationship. When the cell support parts 211 to 215 and the battery cells 145 to 149 are viewed from the axial direction, the relationship in the size and overlap between the cell support parts 211 to 215 and the battery cells 145 to 149 may be understood. The upper-side cell support parts 211 to 213 support the upper-side battery cells 145 to 147 so that the battery cells do not shift in the axial direction. At this time, the upper-side cell support parts 211 and 213 abut with the battery cells 145 and 147 without abutting with the connection tabs 172 and 176. Since the insulating sheet 178 (not shown) is actually interposed, the upper-side cell support parts 211 and 213 support the battery cells 145 and 147 with the insulating sheet 178 sandwiched therebetween. Contact portions 211a and 213a at this time are as shown in FIG. 9.

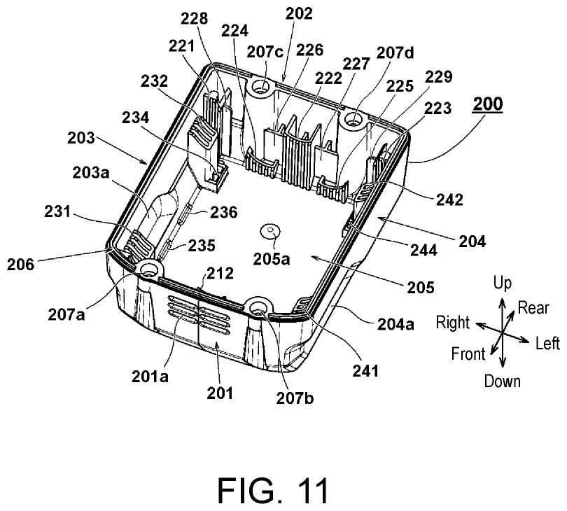

Axial movement of the upper-side battery cell 146 is restricted by the upper-side cell support part 212 formed at a left-right center. That is, the battery cell 146 is supported at a contact portion 212a of the upper-side cell support part 212 via the insulating sheet 178 (not shown) and the connection tab 174. It is also possible to customize the shape of the connection tab 174 to form a special shape to avoid a contact portion with the connection tab 174. However, the same components are used as the connection tabs 172 and 174 to maintain the commonality of the components (the connection tabs 172 and 174) as much as possible, improve the productivity, and reduce the cost. As a countermeasure, the position of the upper-side cell support part 212 in the axial direction is shifted in the axial direction from the other cell support parts 211 and 213 to 215, but this structure will be described later in FIG. 11.

The lower-side battery cells 148 and 179 are held by the lower-side cell support parts 214 and 215 so as not to shift in the axial direction. The lower-side cell support parts 214 and 215 axially support lower portions of the lower-side battery cells 148 and 149. At this time, the lower-side cell support parts 214 and 215 and the battery cells 148 and 149 are not interposed by the connection tabs 172 and 174, but are simply interposed by the insulating sheet 178 (not shown). Then, the battery cell 146 is supported at contact portions 214a and 215a respectively of the lower-side cell support parts 214 and 215 via the insulating sheet 178 (not shown).

As described above, since independent (separated) cell support parts 211 to 215 respectively corresponding to the battery cells 145 to 149 are formed on the inner side of the front wall surface of the lower case 200 of this embodiment, the movement of the battery cells 145 to 149 in the axial direction can be well supported (restricted). Further, excluding the cell support part 212, since the remaining cell support parts 211 and 213 to 215 directly hold the battery cells 145 and 147 to 149 (actually, the insulating sheet 178 is present), it is possible to stably hold (or support) the battery cells with less rattling. Further, although the upper-side cell support parts 211 to 213 and the lower-side cell support parts 214 and 215 opposed to the respective battery cells 145 to 149 are integrally formed with the lower case 200, since they are formed as protrusions independent (separated) from each other, the size and shape of each one may be made into a unique shape, e.g., specifically forming a fragile part to be described later in FIG. 11, and the respective battery cells 145 to 149 can be well supported.

In the cross-sectional views of FIG. 8 and FIG. 9, the cell support parts 211 to 215 formed on the inner side of the front wall 201 of the lower case 200 have been described, and the cell support parts 221 to 225 formed on the inner side of the rear wall 202 of the lower case 200 also have the same shape as the cell support parts 211 to 215. As described above, the upper-side cell support parts and the lower-side cell support parts are respectively provided at two longitudinal ends of the battery cells 145 to 149.

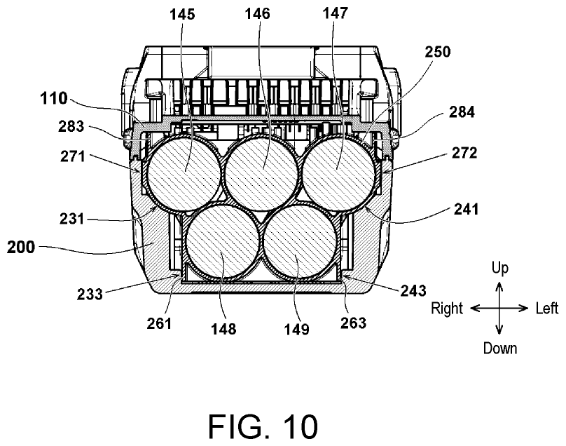

FIG. 10 is a cross-sectional view of a B-B part of FIG. 2. The battery cells 145 to 149 are accommodated inside the lower case 200 in a so-called bale-stack state. Ends of the separator 250 in the left-right direction are formed with abutting surfaces 271 and 272 for good surface contact with the inner wall surface of the lower case 200 to ensure positioning of the separator 250 in the left-right direction with respect to the lower case 200. Further, with a right-side abutting surface 261 of the separator 250 abutting on the cell support part 233, and a left-side abutting surface 263 of the separator 250 abutting on the cell support part 243, the lower-side battery cells 148 and 149 (the separator 250) are held (or supported) so as not to shift in the left-right direction. A part of the outer peripheral surface (cylindrical surface) of the upper-side battery cells 145 and 147 is held by the cell support parts 231 and 241 formed in an arc shape via the separator 250. In the bale-stack, since the number of the upper-side battery cells 145 to 147 arranged in the lateral direction is three while the number of the lower-side battery cells 148 and 149 is as small as two, the cell support parts 231 and 241 are formed to stably hold (or support) the upper-side battery cells 145 and 147 in the up-down direction. By forming the cell support parts 231 and 241, the battery cells 145 and 147 are supported so as not to move downward.

The rib-shaped abutting parts 283 and 284 formed on the upper side at the left and right ends of the separator 250 abut on a lower side of the lower step surface 111 (specifically, in FIG. 3, a portion of the lower step surface 111 that is one step lower than a portion located in front of the step part 114, such as below the rail parts 138a and 138b) of the upper case 110, so that the separator 250 is fixed so as not to move upward. As described above, the cell support parts 231 and 241 are provided on the inner wall side of the lower case 200, and by respectively supporting, from below, the battery cells 145 and 147 located at two ends among the upper-side battery cells, in a battery pack having a plurality of bale-stacked battery cells, the impact resistance can be made extremely high in the stacking method of stacking three cells on the upper side and stacking two cells on the lower side.

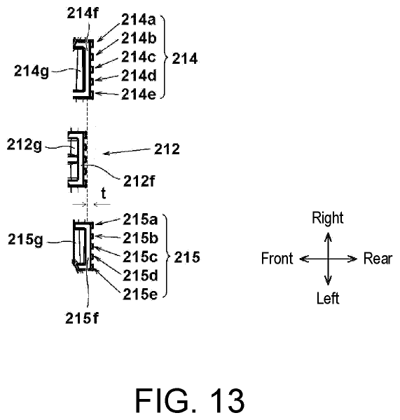

FIG. 11 is a perspective view of the lower case 200 of FIG. 3. As shown in FIG. 8, on the rear side in the longitudinal direction of the battery cell, the upper-side cell support parts 221 to 223 provided at positions opposed to the upper-side battery cells are formed, and the lower-side cell support parts 224 and 225 are provided at positions opposed to the lower-side battery cells. Herein, the contact portions of the upper-side cell support parts 221 to 223 and the lower-side cell support parts 224 and 225 in contact with the separator 250 side are formed in a plurality of rib shapes extending in the up-down direction instead of being formed in a flat surface. The reason for forming the rib shapes is to make it easier to determine the dimensions of the molded product. Compared to a wide surface such as a flat surface, a narrow surface such as a rib has a higher molding accuracy of the dimensions that clamp the battery cell. On the other hand, in each cell support part 221 to 225, with respect to an opposing part (base portion 214f and the like in FIG. 13) which is opposed to each battery cell and in which the rib extends, a space part is formed in a portion (between the opposing part and the inner side of the rear wall 202, on the back side of the rib) opposite to the rib (to be described in detail in FIG. 13). With this space part, when each cell support part is pushed by the battery cell in the longitudinal direction of the battery cell, the opposing part can escape to the space part. That is, since each cell support part 221 to 225 has a space part constituting a fragile part, the opposing part of each cell support part 221 to 225 is easily deformed. Therefore, the battery cell can be reliably supported regardless of a dimensional error of the battery cell. The same applies to the cell support parts 211 to 215 formed on the front side in the longitudinal direction of the battery cell.

The upper-side cell support parts 221 to 223 and the lower-side cell support parts 224 and 225 are configured so that their protruding portions from the rear wall 202 to the front side are independent (separated) from each other. Further, to increase the rigidity of the upper-side cell support part 222, reinforcing ribs 226 and 227 are formed on the left and right sides and are connected with the screw bosses 207c and 207d. In the perspective view of FIG. 11, the inner-side shape of the front wall 201 of the lower case 200 is not shown, but the shape is symmetrical to the inner-side shape of the rear wall 202 seen in the figure. A raised part 205a is formed near the center of the bottom surface 205 of the lower case 200. This is formed to improve the fluidity of material in injection molding.

The upper-side cell support parts 231 and 232 are formed on an inner-side portion of the right side wall 203 of the lower case 200, and the upper-side cell support parts 241 and 242 are formed on an inner-side portion of the left side wall 204. The shape of the upper-side cell support parts 232 and 242 is the same as the shape of the upper-side cell support parts 231 and 241 shown in FIG. 10. The cell support parts 234 and 244 are formed near the bottom surface 205 by the upper-side cell support parts 232 and 242. The cell support parts 234 and 244 have the same shape as the cell support parts 233 and 243, and with the cell support part 234 abutting on the right-side abutting surface (not shown in the figure) of the separator 250, and the cell support part 242 abutting on the left-side abutting surface 264 of the separator 250, the lower-side battery cells 148 and 149 (the separator 250) are held (or supported) so as not to shift in the left-right direction. Reinforcing ribs 235 and 236 are formed to increase the rigidity of the lower case 200. Further, since the recessed parts 203a and 204a are formed on the right side wall 203 and the left side wall 204, the rigidity of the lower case 200 can be further increased.

As described above, the cell support parts 211 to 215 and 221 to 225 are provided at two longitudinal ends in the arrangement direction of the battery cells 145 to 149, and the cell support parts 231, 232, 241 and 242 are provided to support the upper-side battery cells on the left and right sides from below. Since these support parts are made of synthetic resin and are integrally formed with the lower case 200, the rigidity is extremely high.

FIG. 12 is a view of the lower case 200 of FIG. 3, in which (A) is a plan view, (B) is a cross-sectional view of a C-C part of (A), and (C) is a cross-sectional view of a D-D part of (A). In a top view, an interval in the lateral direction (the left-right direction or/and the front-rear direction) between the cell support part 231 and the cell support part 241 and an interval in the lateral direction (the left-right direction or/and the front-rear direction) between the cell support part 232 and the cell support part 242 are formed to be equal. Further, an interval in the left-right direction or/and the front-rear direction between the cell support part 233 and the cell support part 243 and an interval in the left-right direction or/and the front-rear direction between the cell support part 234 and the cell support part 244 are formed to be equal. Herein, the positions in the front-rear direction of the five cell support parts 211 to 215 arranged in the lateral direction (the left-right direction) are not the same, and only the cell support part 212 right in the middle is configured to be slightly offset to the front side. Similarly, among the cell support parts 221 to 225, only the cell support part 222 right in the middle is configured to be slightly offset to the rear side. This is because in addition to the battery cell 146, the thicknesses of the connection tabs 173 and 174 (both see FIG. 5) are required between the cell support parts 212 and 222. This state will be further described with reference to FIG. 13.

FIG. 13 is a partially enlarged view of an E part in (A) of FIG. 12. Herein, only three cell support parts, i.e., the upper-side cell support part 212 and the lower-side cell support parts 214 and 215, are shown. The abutting surface of the cell support part 214 is not flat, but has a shape in which five ribs 214a to 214e extending downward from above extend to the rear side from a base portion 214f. By adjusting an effective area of the abutting surface of the cell support part 214 with the ribs in this manner, it is easy to determine the dimensions of the molded product. This is because compared to a wide surface such as a flat surface, a narrow surface such as a rib has a higher molding accuracy of the dimensions that clamp the battery cell. On the other hand, in the cell support part 214, with respect to the base portion 214f, a space part 214g is formed on a side opposite to the rib, i.e., between the inner surface of the front wall 201 and the inner surface (back side of the rib) of the base portion 214f. With the space part 214g, the base portion 214f can escape to the space part 214g when the cell support part 214 is pushed by the battery cell 148 in the longitudinal direction. That is, since the cell support part 214 has the space part 214g constituting a fragile part, the base portion 21f of the cell support part 214 is easily deformed. Therefore, the battery cell can be reliably supported regardless of a dimensional error of the battery cell. The same applies to the other cell support parts 211 to 213, 215, and 221 to 225. Further, in cooperation with the insulating sheet 178 interposed between the cell support part 214 and the battery cell 148, the cell support part 214 effectively absorbs an impact during movement of the battery cell 148. The same applies to the other cell support parts.

Referring to FIG. 12 again, in (B) of FIG. 12, since the abutting portions of the cell support parts 231 and 232 abutting with the separator 250 are also not flat but are formed of four ribs, the strength is high, and the battery cell 145 can be reliably supported even if a downward impact applied to the battery cell 145 occurs. Since the lower-side cell support parts 233 and 234 do not receive a downward force of the separator 250 from above but only suppress the movement in the left-right direction, the shape of their inner side surface is flat. A fragile part is not formed in the cell support parts 231, 232, 233, and 234.

(C) of FIG. 12 shows the upper-side cell support parts 221 to 223 and the lower-side cell support parts 224 and 225 formed on the inner side of the rear wall 202. Herein, the cell support parts 222, 224, and 225 are formed with five parallel ribs which are continuous in the up-down direction, and the cell support parts 221 and 223 are formed with three parallel ribs which are continuous in the up-down direction. These ribs are integrally molded portions formed during injection molding of the lower case 200.

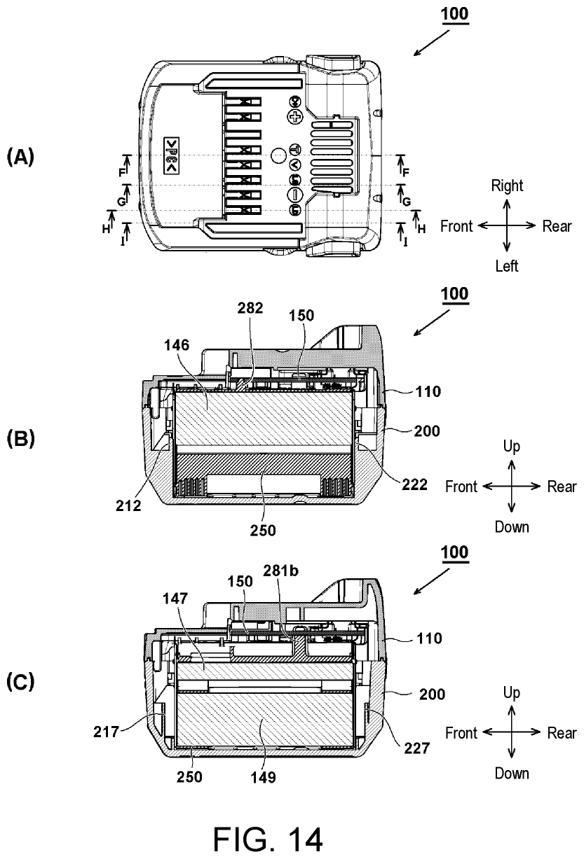

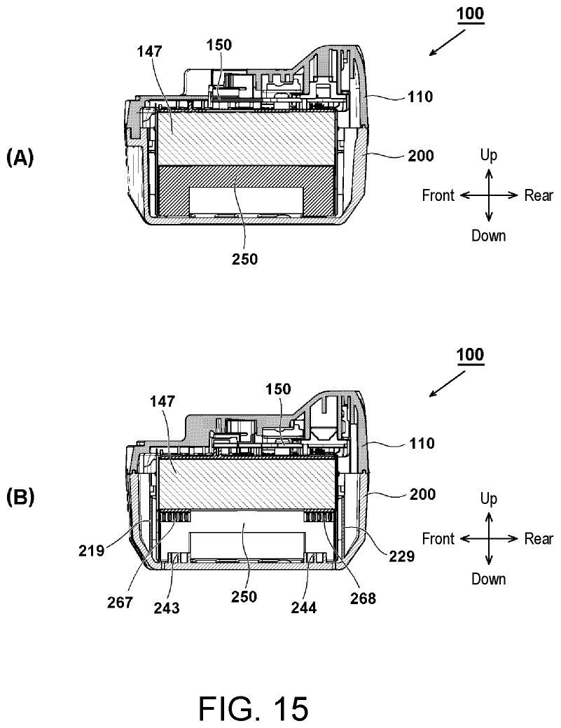

FIG. 14 is a view of the battery pack 100 of this embodiment, in which (A) is a top view, (B) is a cross-sectional view of an F-F part of (A), and (C) is a cross-sectional view of a G-G part of (A). The cross section of the F-F part shown in (B) of FIG. 14 is a vertical cross-sectional view at a center in the left-right direction of the battery pack 100. The battery cell 146 is formed to be slightly longer than the length of the separator 250 in the front-rear direction. A lower part at a front end of the battery cell 146 is held by the cell support part 212, and a lower part at a rear end is held by the cell support part 222. The column part 282 protruding upward from the separator 250 is inserted into a through-hole formed in the circuit board 150.

(C) of FIG. 14 is a cross section of the G-G part passing through a part of the battery cell 147 and 149. The screw boss 281b for fixing the circuit board 150 is formed on the separator 250 at this cross-sectional position. It is a vertical cross section slightly to the left of the axial center position of the battery cell 149, and a reinforcing rib 217 formed between the cell support parts 212 and 215 and a reinforcing rib 227 formed between the cell support parts 222 and 225 pass through this position. As is clear from the figure, the reinforcing ribs 217 and 227 are formed at positions sufficiently away from the battery cell 149 and are at positions without interference.

(A) of FIG. 15 is a cross-sectional view of an H-H part of (A) of FIG. 14. This cross-sectional position is a vertical cross section passing through the axial center position of the battery cell 147, and is a position through which the lower side surface of the separator 250 passes. This cross-sectional position is a cross-sectional position which passes through the rib portions of the cell support parts 243 and 244 extending in the vertical direction.

(B) of FIG. 15 is a cross-sectional view of an I-I part of (A) of FIG. 14. This cross-sectional position is a vertical cross section slightly to the left of the axial center position of the battery cell 147, is at a position where the lower side surface of the separator 250 can be seen, and the reinforcing ribs 267 and 268 can be confirmed. Further, this cross-sectional position is a cross-sectional position which passes through the rib portions of the cell support parts 243 and 244 extending in the vertical direction.

According to the present invention, the large-diameter battery cells 145 to 149 are bale-stacked to reduce the height, and since the longitudinal direction of the battery cells is not the transverse orientation but the longitudinal orientation arranged in the front-rear direction, it is possible to realize a compact yet high-capacity battery pack 100. Further, since the cell support parts suppress the shake in the axial direction at two ends in the length direction of the battery cells, it is possible to realize a battery pack which is strong against impact and has excellent durability. Further, since the cell support part is formed to be independent (separated) for each battery cell, even if the length of the battery cell varies, it can be satisfactorily dealt with.

Although the present invention has been described above based on the embodiments, the present invention is not limited to the above embodiments, and various modifications may be made without departing from the spirit of the present invention. For example, the shape of the separator may be changed to apply to a battery cell other than a cylindrical shape, such as a prismatic shape. Further, the battery cells may include two upper-side battery cells and three lower-side battery cells, or the number of battery cells may be a number other than five. Further, it is not necessary to bale-stack the battery cells, and the lower-side battery cells may be arranged directly below the respective upper-side battery cells, as in the conventional battery pack shown in FIG. 16. Further, the orientation of the battery cell in the case may be arranged so that the longitudinal direction of the battery pack is oriented in the left-right direction, as in the conventional battery pack shown in FIG. 16.

### REFERENCE SIGNS LIST

1 . . . Electrical tool main body; 2 . . . Housing; 2a . . . Body part; 2b . . . Handle part; 4 . . . Operation switch; 8 . . . Front end tool holding part; 9 . . . Front end tool; 10 . . . Battery pack mounting part; 11a, 11b . . . Rail part; 12 . . . Curved part; 14 . . . Protruding part; 20 . . . Terminal part; 20a . . . Vertical surface; 20b . . . Horizontal surface; 21f . . . Base portion; 22 . . . Positive electrode input terminal; 27 . . . Negative electrode input terminal; 28 . . . LD terminal (abnormal signal terminal); 100 . . . Battery pack; 110 . . . Upper case; 111 . . . Lower step surface; 113 . . . Opening; 114 . . . Step part; 115 . . . Upper step surface; 120 . . . Slot group arrangement region; 121 to 128 . . . Slot; 131 . . . Stopper part; 132 . . . Raised part; 134 . . . Slit; 138a, 138b . . . Rail part; 141a, 141b . . . Latch; 142a, 142b . . . Locking part; 145 to 149 . . . Battery cell; 150 . . . Circuit board; 150a . . . Notch; 155a, 155b . . . Screw; 161 . . . Positive electrode terminal; 164 . . . T terminal; 165 . . . V terminal; 166 . . . LS terminal; 167 . . . Negative electrode terminal; 168 . . . LD terminal; 171 to 176 . . . Connection tab; 172a, 173a, 174a, 175a, 176a . . . Lead-out part; 178, 179 . . . Insulating sheet; 200 . . . Lower case; 201 . . . Front wall; 201a . . . Slit; 202 . . . Rear wall; 203 . . . Right side wall; 203a, 204a . . . Recessed part; 204 . . . Left side wall; 205 . . . Bottom surface; 205a . . . Raised part; 206 . . . Opening; 207a to 207d . . . Screw boss; 211 to 213 . . . (Upper-side) cell support part; 211a to 215a . . . Contact portion; 212f . . . Base portion; 214 to 215 . . . (Lower-side) cell support part; 214a to 214e . . . Rib; 214f . . . Base portion; 214g . . . Space part; 215a to 215e . . . Rib; 215f . . . Base portion; 217, 219 . . . Reinforcing rib; 221 to 223 . . . (Upper-side) cell support part; 224 to 225 . . . (Lower-side) cell support part; 226 to 229 . . . Reinforcing rib; 231 to 234 . . . Support part; 235, 236 . . . Reinforcing rib; 241 to 244 . . . Support part; 250 . . . Separator; 251 to 255 . . . Cell accommodating part; 257, 258 . . . Leg part; 261, 262 . . . Right-side abutting surface (of separator); 263, 264 . . . Left-side abutting surface (of separator); 267, 268 . . . Rib; 271 to 276 . . . Abutting surface (abutting part); 281a, 281b . . . Screw boss; 282 . . . Column part; 283 to 286 . . . Abutting part; 290 . . . Protruding part; 300 . . . Battery pack; 310 . . . Upper case; 320 . . . Lower case; 330 . . . Separator; 341 to 348 . . . Battery cell

1. A battery pack comprising:
a case forming an outer frame;
a plurality of battery cells formed by bale-stacking upper-side battery cells located on an upper side and lower-side battery cells located on a lower side in the case; and
an upper-side cell support part and a lower-side cell support part, wherein in a longitudinal direction of the battery cell, the upper-side cell support part is provided at a position opposed to the upper-side battery cell, and the lower-side cell support part is provided at a position opposed to the lower-side battery cell,
wherein the upper-side cell support part and the lower-side cell support part opposed to each battery cell are independent of each other, and
wherein the upper-side cell support part and the lower-side cell support part are integrally formed with the case.

2. (canceled)

3. The battery pack according to claim 1, wherein the upper-side cell support part and the lower-side cell support part are each provided on two sides in the longitudinal direction of the battery cell.

4. The battery pack according to claim 1, wherein the upper-side cell support part and the lower-side cell support part have a fragile part.

5. The battery pack according to claim 1, comprising a support part supporting the upper-side battery cell from below.

6. The battery pack according to claim 5, wherein in the case, more upper-side battery cells are arranged in a radial direction and bale-stacked than the lower-side battery cells, and
the support part supports an upper-side battery cell located at an end of the upper-side battery cells from below.

7. The battery pack according to claim 6, wherein three upper-side battery cells are arranged in the radial direction and two lower-side battery cells are arranged in the radial direction to be bale-stacked, and
the support part supports each of battery cells located at two ends of the upper-side battery cells from below.

8. The battery pack according to claim 5, wherein the support part is integrally formed with the case.

9. A battery pack comprising:
a case forming an outer frame;
a plurality of battery cells formed by bale-stacking upper-side battery cells located on an upper side and lower-side battery cells located on a lower side in the case, wherein in a radial direction of the battery cell, more upper-side battery cells are arranged than the lower-side battery cells; and
a support part supporting the upper-side battery cells located at two ends in an arrangement direction of the battery cells from below,
wherein the support part is integrally formed with the case and is provided to protrude inward from the case.

10. (canceled)

11. The battery pack according to claim 9, comprising an upper-side cell support part and a lower-side cell support part, wherein in a longitudinal direction of the battery cell, the upper-side cell support part is provided at a position opposed to the upper-side battery cell and the lower-side cell support part is provided at a position opposed to the lower-side battery cell, wherein the upper-side cell support part and the lower-side cell support part opposed to each battery cell are independent of each other.

12. The battery pack according to claim 11, wherein the upper-side cell support part and the lower-side cell support part are each provided on two sides in the longitudinal direction of the battery cell.

13. The battery pack according to claim 11, wherein the upper-side cell support part and the lower-side cell support part have a fragile part.

14. The battery pack according to claim 1, wherein the upper-side cell support part is provided to protrude inward from the case, and the lower-side cell support part is provided to protrude inward from the case at a position lower than the upper-side cell support part in a state separated from the upper-side cell support part.

15. An electrical instrument comprising:
the battery pack according to claim 1; and
an electrical instrument main body comprising a battery pack mounting part having a rail groove to which the battery pack is capable of being mounted and a locking claw which is locked to the rail groove,
wherein a load part which consumes electric power supplied from the battery pack is built in the electrical instrument main body.
